(19) United States
(12) Patent Application Publication
(10) Pub. No.: US 2007/0107236 A1
(43) Pub. Date: May 17, 2007

(54) Hand-Held Cut-Off Machine

(75) Inventor: Klaus-Martin Uhl, Plochingen (DE)

Correspondence Address: GUDRUN E. HUCKETT DRAUDT, LONSSTR. 59, WUPPERTAL, 42289, DE

(73) Assignee: ANDREAS STIHL AG & CO. KG, Waiblingen (DE)

(21) Appl. No.: 11/539,333

(22) Filed: Oct. 6, 2006

(30) Foreign Application Priority Data
Oct. 18, 2005 (DE) 10 2005 049 766.7

(51) Int. Cl. B26B 7/00

(52) U.S. Cl. 30/276

(57) ABSTRACT

A hand-held cut-off machine has a motor housing and a drive motor arranged in the motor housing. An extension arm is connected to the motor housing and a cutting wheel driven by the drive motor is supported on the extension arm. A water connector is arranged on the cut-off machine. A conduit is connected to the water connector and extends from the water connector to the cutting wheel for supplying water to the cutting wheel. The conduit has an integrated conduit section that is integrated into the extension arm.

### BACKGROUND OF THE INVENTION

The invention relates to a hand-held cut-off machine with a motor housing receiving a drive motor, with a cutting wheel driven by the drive motor and supported on an extension arm, and with a conduit for water extending from a water connector to the cutting wheel.

Hand-held cut-off machines of known configuration have a cutting wheel that is rotatably drivable about an axis of rotation and is acted on by a drive motor that is in particular embodied as an internal combustion engine. The drive motor is arranged in a motor housing and the cutting wheel is rotatably supported on an extension arm. The extension arm comprises a drive, for example, in the form of a belt drive by means of which the rotary movement of the drive motor is transmitted onto the cutting wheel.

In the area of the cutting wheel and in particular in the area of the cover that partially covers the cutting wheel, one or several spray nozzles are provided through which water is guided into the cutting area. The water is provided for binding the grinding dust and for cooling the cutting wheel. For this purpose, the cut-off machine is provided with a water connector through which water from a container or a public water supply system is supplied to the system. A conduit of the cut-off machine leads from the water connector to the cutting wheel and is positioned external to the cut-off machine for maintaining a compact configuration.

In operation, the external positioning of the conduit can be disturbing. The conduit can be caught on things and can be damaged. Also, proper guiding during the cutting operation can be impaired.

### SUMMARY OF THE INVENTION

The invention has the object to further develop a cut-off machine of the aforementioned kind in such a way that its susceptibility to failure is reduced.

According to the present invention, a cut-off machine is proposed in which a section of the water-carrying conduit is integrated into the extension arm. The integration of this section into the extension arm is more than providing a simple fastening function. In the area of integration, the integrated conduit section is protected from impact and from catching on things. Externally arranged conduit sections extend without protection and are limited with regard to their movability only across a comparatively short distance so that in this area the risk of damage or catching on things is also reduced. The extension arm in usual configurations is suitable for receiving the aforementioned integrated conduit section without this requiring a significantly increased size. The cut-off machine remains compact for enabling excellent handling.

The conduit section can be integrated into a supporting element of the extension arm. Preferably, it is integrated into a housing of the extension arm which covers a drive for the cutting wheel. A cross-sectional increase of supporting parts is not required. The extension arm housing including the integrated conduit section can be easily removed for maintenance work. Existing cut-off machines can be retrofitted with minimal expenditure with a extension arm housing that receives the conduit section.

It can be expedient to arrange the integrated section of the conduit so as to be only partially recessed within the extension arm. Preferably, the integrated section extends within the contour of a lateral outer surface of the extension arm. Primarily this lateral outer surface is subject to the risk of contact or impact. The extension of the conduit within the contour of this lateral outer surface has the effect that an object impacting the outer surface will slide off the lateral outer surface without the guiding precision of the cut-off machine being impaired significantly and without causing the risk of catching on things.

The integrated section of the conduit can be an integrated pipe or a channel. Expediently, the integrated section, in particular the entire conduit, is configured as a flexible hose. This provides an inexpensive water carrying action while avoiding hose couplings, separating locations and the like; if wear occurs, exchange is easy. A complete flexible configuration facilitates adaptation labor and enables with minimal constructive expenditure a swiveling of the protective cover that covers the cutting wheel and has spray nozzles arranged thereat.

In a preferred embodiment, the integrated section of the conduit is secured, especially by clamping, in an outwardly open receiving groove. For this purpose, at least one inwardly oriented clamping tooth is expediently provided on an outer edge of the receiving groove, wherein in particular three such clamping teeth are provided that are alternatingly positioned on both edges of the receiving groove and are staggered relative to one another in the longitudinal direction of the groove. The outwardly open receiving groove enables easy mounting of the flexible hose and provides the possibility of visual control by the operator. The clamping tooth or clamping teeth contribute to securing the conduit section within the receiving groove. The alternating arrangement of the three clamping teeth also effects an axial positional securing action of the integrated conduit section. Its clamping action leads to securing against axial sliding but allows at the same time a manual axial position adjustment.

In an advantageous embodiment, the integrated section of the conduit, relative to a usual working position of the cut-off machine, is guided toward the cutting wheel in a vertical direction from bottom to top. The water connector at the intake side is positioned in the area of the bottom of the cut-off machine so that it has a sufficient spacing to the grips of the cut-off machine and does not impair the operator during operation. On the other hand, a downstream compensation section of the conduit that extends from the integrated conduit section to the spray nozzle is provided at least partially above the extension arm and thus at a comparatively great spacing relative to the surface to be machined. The extension arm is positioned between the surface to be worked on and the exposed compensation section and therefore provides an additional protective function. Because of the extension in the vertical direction, a significant length of the integrated conduit section extending in the longitudinal direction of the cut-off machine or the lateral surface of the extension arm is prevented. The risk of contact in this area is reduced.

For enhancing the protective function, the area of the integrated section is arranged preferably in the area of the grip pipe of the cut-off machine. Relative to the usual working position of the cut-off machine, the integrated section of the conduit is expediently positioned a short distance in front of the grip pipe in longitudinal direction; the grip pipe is guided in an arc shape about an intake section of the conduit that extends in the longitudinal direction. The grip pipe extending in an arc shape about the intake section acts as a protective bow for the intake section and for the integrated section of the water conduit. The lateral projection of the grip pipe provides this protective function not only in the lateral direction but also upwardly, downwardly, at a slant forwardly, and at a slant rearwardly.

In a preferred embodiment, a protective cover is provided that covers the cutting wheel partially and is pivotably adjustable; it has at least one spray nozzle that is directed toward the cutting wheel and is in flow connection with the conduit wherein a flexible compensation section of the conduit between the integrated section and the spray nozzle is positioned in an arc shape. The arc-shaped positioning enables a free pivoting action of the protective cover into different pivot positions that are matched to the work to be performed, respectively. Securing the integrated conduit section on the extension arm of the cut-off machine limits the movability of the compensation section positioned in an arc shape to the deformation required for adjustment. Accidental flexible deformations of the compensation section, particularly in the lateral direction, are prevented so that the risk of damage or catching on things is reduced.

### BRIEF DESCRIPTION OF THE DRAWINGS

One embodiment of the invention will be explained in more detail in the following with the aid of the drawing.

FIG. 1 shows In a perspective side view a cut-off machine according to the invention with a water connector and a conduit section integrated into a housing of the extension arm.

FIG. 2 shows in an enlarged detail view the arrangement according to FIG. 1 in the area of the integrated conduit section with details in regard to a clamping attachment in a receiving groove.

FIG. 3 is a plan view onto the cut-off machine according to FIG. 1 in the area of the extension arm and the protective cover attached thereto showing further details in regard to how the hose is guided.

### DESCRIPTION OF PREFERRED EMBODIMENTS

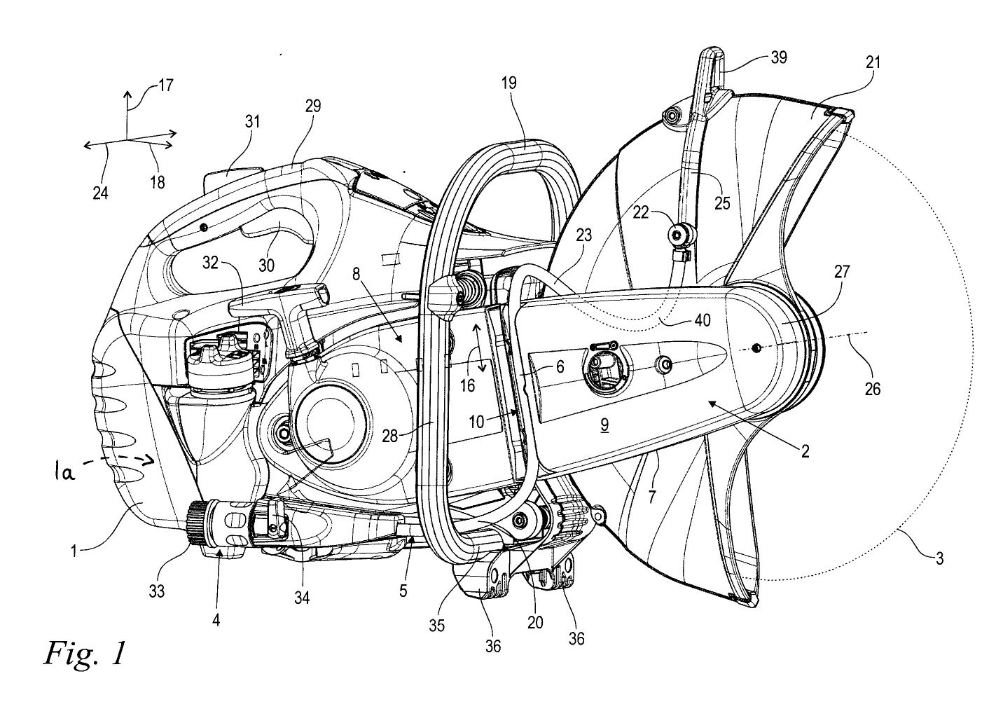

FIG. 1 shows in a perspective view a hand-held cut-off machine embodied according to the invention with a motor housing 1, an extension arm 2, and a cutting wheel 3. In the motor housing 1 a drive motor 1a, not illustrated in detail, is arranged which drive motor 1a is an internal combustion engine in the illustrated embodiment but can also be an electric motor. The cut-off machine is shown in its usual working orientation; the arrows 17, 18, 24 define a vertical direction, a longitudinal direction, and a lateral direction, respectively.

Laterally on the motor housing 1 a cable pull starter 32 for starting the internal combustion engine is arranged. Relative to the vertical direction 17 and the longitudinal direction 18, an upper rear grip 29 is provided on the motor housing 1 on a side facing the operator; for controlling the motor output a throttle lever 30 and also a throttle lock 31 are arranged on the grip. Relative to the longitudinal direction 18, in front of the rear grip 29 on the end of the motor housing 1 facing away from the operator, a forward grip pipe 19 is provided that extends in an arc shape about the motor housing 1 approximately in a plane defined by the vertical direction 17 and the lateral direction 24. A lateral grip section 28 of the grip pipe 19 extends approximately in the vertical direction 17 while below the motor housing 1 an adjoining arc-shaped grip section 35 extends approximately in the lateral direction 24 and is attached with its free end on the motor housing 1. In this area there are also legs 36 for setting down the cut-off machine.

On the lateral surface of the motor housing 1 shown here, the extension arm 2 is arranged that, beginning at the motor housing 1, extends essentially in the longitudinal direction 18 and projects past the motor housing 1. On a forward end 27 of the extension arm 2 that is arranged opposite the motor housing 1 when viewed in the longitudinal direction 18, the cutting wheel 3 is rotatably supported about axis of rotation 26 wherein the axis of rotation 26 extends in the lateral direction 24. Within the extension arm 2, a drive 8 is positioned that in the illustrated embodiment is a belt drive and transmits the motor output of the drive motor onto the cutting wheel 3. The drive 8, not shown in detail, is covered by housing 7 of the extension arm 2. The extension arm housing 7 has a substantially plane outer surface 9 that is positioned approximately in a plane defined by the vertical direction 17 and the longitudinal direction 18.

A conduit 5 for water is provided for binding the grinding dust that is produced in operation of the cut-off machine as well as for cooling the cutting wheel 3; the conduit extends from a water connector 4 to the area of the cutting wheel 3. For this purpose, the water connector 4 has a hose coupling 33 that can be connected to a water container or a public water supply system. In the flow direction downstream of the connector, a control lever 34 is provided in the water connector 4 by means of which the flow rate of the water can be adjusted.

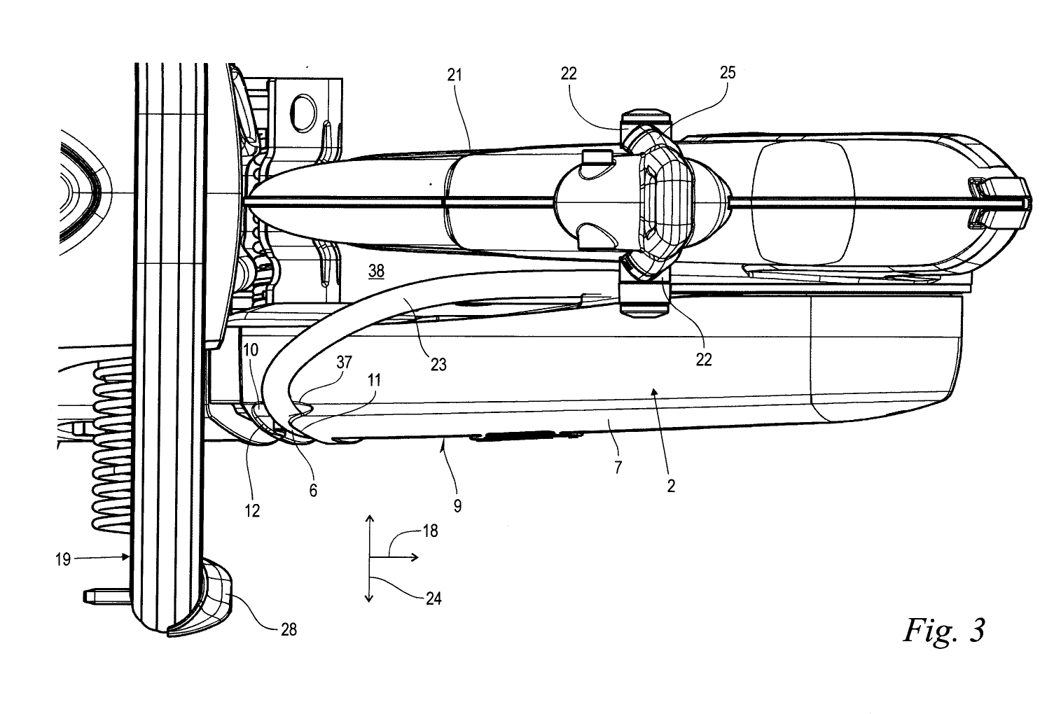

It can be expedient to guide the conduit 5 from the water connector 4 to a hub of the cutting wheel 3, for example. In the illustrated embodiment a protective cover 21 is provided that covers the cutting wheel 3 partially and is provided with a total of two spray nozzles 22. A first spray nozzle 22 is arranged in a lateral wall of the protective cover 21 while the other spray nozzle 22, not illustrated here but illustrated in FIG. 3, is arranged on the opposite lateral wall of the protective cover 21. On the inner side of the protective cover 21, the spray nozzle nozzles 22 are directed onto the lateral surfaces of the cutting wheel 3, respectively.

A bow 25 with grip 39 extends arc-shaped on the outer side of the protective cover 21 from one lateral surface to the opposite lateral surface and realizes a flow-conducting connection between the two spray nozzles 22. The conduit 5 is connected to the illustrated spray nozzle 22 so as to be in flow communication. A flow of water that is introduced through the water connector 4 and supplied through the conduit 5 is divided at the first spray nozzle 22 illustrated here. A first partial flow is supplied directly to the cutting wheel 3 while a second partial flow is guided through the bow 25 onto the opposite side of the protective housing 21 and is directed against the cutting wheel 3 by means of the spray nozzle 22 (FIG. 3) arranged at the opposite side.

The water connector 4 is positioned laterally below the motor housing 1 and extends approximately parallel to the longitudinal direction 18. The adjoining conduit 5 is configured as a monolithic flexible hose extending between the water connector 4 and the first spray nozzle 22. A first section of the conduit 5 relative to the flow direction is a supply section 20 that leads away from the water connector 4 approximately parallel to the longitudinal direction 18 and extends to the extension arm 2. Relative to the lateral direction 24, the water connector 4 and the conduit 5 are recessed relative to the outer surface 9 of the extension arm 2. In contrast to this, the lateral grip section 28 projects with a significant length in the lateral direction 24 past the outer surface 9 of the extension arm 2 and is guided together with the lower grip section 35 in an arc shape about the supply section 20. The lateral grip section 28 effects in the lateral direction a protective function relative to the water connector 4 and conduit 5 while such a protective function in a direction opposite to the vertical direction 17 is provided by the lower grip section 35 and the legs 36. Because of the comparatively large lateral projecting length of the lateral grip section 28 and the projecting length of the module comprised of the lower grip section 35 and the legs 36 in a direction opposite to the vertical direction 17, this protective function extends at least partially also in the longitudinal direction 18.

A receiving groove 10 is formed in the outer surface 9 of the extension arm housing 7 and has a longitudinal direction 16 that extends approximately in the vertical direction 17. In the receiving groove 10 an integrated conduit section 6 of the conduit 5 is arranged to be countersunk such that, relative to the lateral direction 24, it is recessed relative a contour of the extension arm housing 7 as defined by the lateral outer surface 9.

Relative to the longitudinal direction 18, the receiving groove 10 is positioned with integrated conduit section 6 at a minimal spacing in front of the lateral grip section 28 wherein the supply section 20 that is guided through the arc shape of the grip pipe 19 is bent upwardly near the receiving groove 10 and, extending in the vertical direction 17 from bottom to top, passes into the integrated conduit section 6. The integrated conduit section 6 and the lateral grip section 28 extends approximately parallel to one another. The supply section 20 and the integrated conduit section 6 are therefore both positioned in the area of the protective action of the grip pipe 19.

In the illustrated arrangement the flow direction of the water within the integrated conduit section 6 is in the vertical direction 17 from bottom to top. In the flow direction, a compensation section 23 adjoins the integrated conduit section 6 and extends in three-dimensional arc approximately in an S-shape from the extension arm 2 to the first spray nozzle 22. A section 40 of the compensation section 23, indicated in dashed lines, is positioned relative to the lateral direction 24 between the extension arm 2 and the protective cover 21. For assisting this course, the compensation section 23 is connected such to the illustrated spray nozzle 22 that it extends in the connecting area parallel to the illustrated leg of the bow 25 approximately from a radial inward position to a radial outward position.

The protective cover 21 is pivotably secured on the extension arm 2 wherein a grip 39 is provided on the bow 25 for manually pivoting the cover. A pivot position is illustrated in which the grip 39 is approximately in its rear position. From here, the grip 39 can be pivoted in the longitudinal direction 18 to the front together with the protective cover 20. The pivot axis of the protective cover 21 is identical to the rotary axis 26 of the cutting wheel 3. The configuration of the conduit 5 as a flexible hose enables an elastic deformation of the compensation section 23 so that it can follow the pivot movement of the spray nozzle 22. When pivoting the protective cover 21 to the front, the compensation section 23 as a whole comes to rest above the extension arm 2. The compensation section 23 opening essentially radially into the bow 25 in combination with integrated attachment of the section 6 on the extension arm 2 lead to the compensation section 23 having no tendency to project in the lateral direction 24 past the outer surface 9. Instead, upon returning the protective cover 21 by pivot action into the illustrated position, the area 40 of the compensation section 23 is returned automatically into the position between the extension arm 2 and the protective cover 21 in which position it is protected against outer loads.

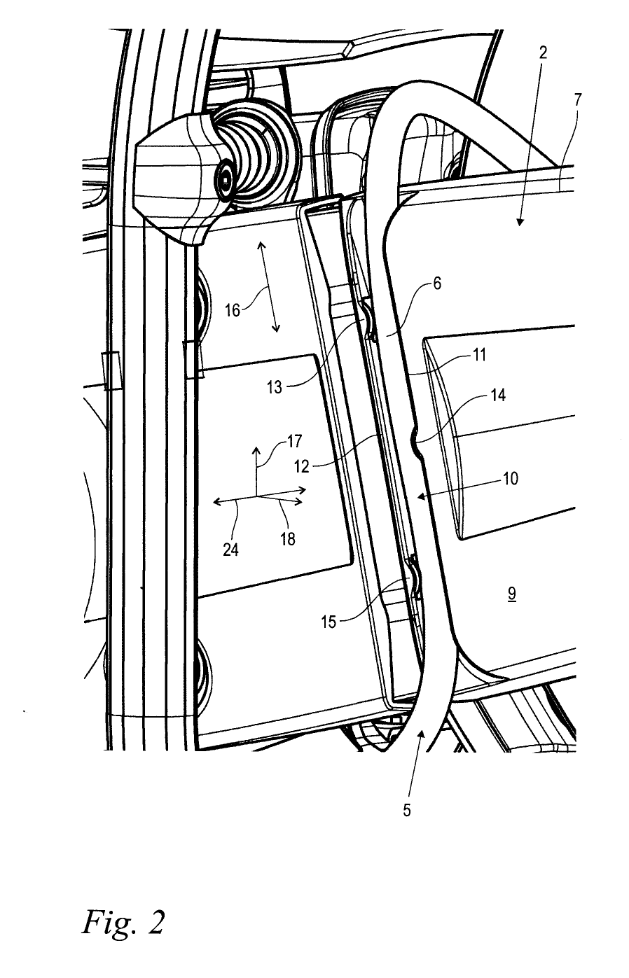

FIG. 2 shows an enlarged detail view of the arrangement according to FIG. 1 in the area of the receiving groove 10. The receiving groove 10 is recessed into the housing 7 of the extension arm 2 such that it is open in the lateral direction 24 toward the exterior. Its depth relative to the lateral direction 24 is such that the diameter of the section 6 of the conduit 5 is completely received within the receiving groove 10. The approximately circular cross-section of the integrated conduit section 6 therefore does not project in the radial direction past the outer surface 9. Instead, the cross-section of the integrated conduit section 6 is integrated about the entire length of the receiving groove 10 completely within the extension arm 2 in such a way that it extends, relative to the lateral contour that is defined by the outer surface 9, completely within the extension arm 2 or its housing 7. As an alternative, a pipe can be provided that extends within the contour of the extension arm 2 and through which the conduit 5 is pushed or which itself forms the integrated conduit section 6.

Relative to the longitudinal direction 18, the receiving groove 10 is delimited by a forward edge 11 and a rear edge 12 that are both oriented in the longitudinal direction 16 of the receiving groove 10 and are both positioned in the plane of the lateral outer surface 9 of the extension arm housing 7. Centrally at the forward edge 11 a clamping tooth 14 is arranged that extends past the leading edge 11 in a direction opposite to the longitudinal direction 18 into the receiving groove 10; in the lateral direction 24, it extends from the outer surface 9 or the edge 11 to the bottom 37 of the receiving groove 10 illustrated in FIG. 3. The opposing edge 12 is provided with two additional clamping teeth 13, 15 that are mirror-symmetrical to the clamping tooth 14 and are identical to it otherwise. Relative to the vertical direction 17 or the longitudinal direction 16 of the receiving groove 10, the clamping teeth 13, 14, 15 are arranged alternatingly on the two edges 11, 12 so that the clamping tooth 14 on the edge 11 is arranged above the clamping tooth 15 on the edge 12 and the clamping tooth 13 on the edge 12 is arranged above clamping tooth 14. Between these clamping teeth 13, 14, 15 and the oppositely positioned sidewalls of the receiving groove 10, the integrated conduit section 6 of the conduit 5 in the form of a flexible hose is secured by clamping in the receiving groove 10. The clamping action acts in all direction 17, 18, 24 and secures the integrated conduit section 6 but allows for manual position adjustment of the integrated conduit section 6 in the longitudinal direction 16 of the receiving groove 10.

FIG. 3 shows a plan view of the arrangement according to FIG. 1 in the area of the extension arm 2 and the protective cover 21. It can be seen that the lateral grip section 28 of the grip pipe 19 projects in the lateral direction 24 past the lateral outer surface 9 of the extension arm 2 by an amount that is greater than a spacing of the integrated conduit section 6 extending in the longitudinal direction 16 from the grip pipe 19.

The receiving groove 10 integrated into the extension arm housing 7 has an approximately C-shaped cross-section wherein a bottom 37 of the receiving groove 10 relative to the lateral outer surface 9 is recessed in the lateral direction 24. In the area of the bottom 37 the receiving groove 10 has a width that is greater than the opening width between the edges 11, 12 in the longitudinal direction 18. An exterior side of the integrated conduit section 6 is at least partially surrounded or covered by the edge 11 wherein the cross-section of the integrated conduit section 6 is recessed relative to the lateral outer surface 9 and the edges 11, 12 in the lateral direction 24. The edge 11 and optionally also the edge 12 assist the clamping teeth 13, 14, 15 illustrated in FIG. 2 in the clamping fixation of the integrated conduit section 6. The spacing of the two edges 10, 11 in the longitudinal direction 18 can be smaller than the diameter of the flexible integrated conduit section 6 so that, for mounting, this section must be pressed into the receiving groove 10 with elastic cross-sectional deformation so as to snap into place.

The illustration according to FIG. 3 also shows that relative to the lateral direction 24 between the extension arm 2 and the protective cover 21 an intermediate space 38 is provided. Starting at the integrated conduit section 6 or the receiving groove 10, the compensation section 23 extends first in an arc shape in the lateral direction 24 to the intermediate space 38 from where it continues on to the spray nozzle 22. It can be seen that the bow 25 is arranged mirror-symmetrically to a center plane of the protective cover 21 and is provided with two diametrically opposed spray nozzles 22. About the circumferential contour of the protective cover 21, a water channel not illustrated, extends through the bow 25 for guiding the water flow from the compensation section 23 and the first spray nozzle 22 to the second spray nozzle 22.

The specification incorporates by reference the entire disclosure of German priority document 10 2005 049 766.7 having a filing date of Oct. 18, 2005.

While specific embodiments of the invention have been shown and described in detail to illustrate the inventive principles, it will be understood that the invention may be embodied otherwise without departing from such principles.

What is claimed is:

1. A hand-held cut-off machine comprising:
a motor housing;
a drive motor arranged in the motor housing;
an extension arm connected to the motor housing;
a cutting wheel driven by the drive motor and supported on the extension arm;
a water connector arranged on the cut-off machine;
a conduit connected to the water connector and extending from the water connector to the cutting wheel for supplying water to the cutting wheel;
wherein the conduit has an integrated conduit section that is integrated into the extension arm.

2. The cut-off machine according to claim 1, further comprising a drive drivingly connecting the drive motor to the cutting wheel, wherein the extension arm has an extension arm housing that covers the drive, wherein the integrated conduit section is integrated into the extension arm housing.

3. The cut-off machine according to claim 1, wherein the integrated conduit section extends within a contour of a lateral outer surface of the extension arm.

4. The cut-off machine according to claim 1, wherein the integrated conduit section is a flexible hose.

5. The cut-off machine according to claim 4, wherein the conduit as a whole is a flexible hose.

6. The cut-off machine according to claim 1, wherein the extension arm has an extension arm housing and the integrated conduit section is secured in an outwardly open receiving groove of the extension arm housing.

7. The cut-off machine according to claim 6, wherein the integrated conduit section is secured by a clamping action in the receiving groove.

8. The cut-off machine according to claim 6, wherein the receiving groove has two outer edges provided with at least one inwardly oriented clamping tooth.

9. The cut-off machine according to claim 8, wherein three of the at least one clamping tooth are alternatingly arranged on the two outer edges of the receiving groove and staggered relative to one another in a longitudinal direction of the receiving groove.

10. The cut-off machine according to claim 1, wherein the integrated conduit section, relative to an operating position of the cut-off machine, extends toward the cutting wheel in a vertical direction from bottom to top.

11. The cut-off machine according to claim 1, wherein the integrated conduit section is arranged in the area of a grip pipe of the cut-off machine.

12. The cut-off machine according to claim 11, wherein the integrated conduit section, relative to an operating position of the cut-off machine, is positioned in a longitudinal direction of the cut-off machine in front of the grip pipe, wherein the grip pipe is guided in an arc shape about a supply section of the conduit, wherein the supply section extends approximately in the longitudinal direction of the cut-off machine.

13. The cut-off machine according to claim 1, further comprising a pivotably adjustable protective cover covering the cutting wheel partially, wherein the protective cover has at least one spray nozzle directed toward the cutting wheel and connected in flow connection to the conduit, wherein the conduit has a flexible compensation section that is positioned in an arc shape between the integrated conduit section and the at least one spray nozzle.
